(19) United States
(12) Patent Application Publication
(10) Pub. No.: US 2025/0035267 A1
(43) Pub. Date: Jan. 30, 2025

(54) METHOD FOR ESTIMATING A VOLUME OF A RESERVOIR TO BE FILLED FROM A PRESSURIZED FLUID DISTRIBUTION STATION

(71) Applicant: L'Air Liquide, Societe Anonyme pour l'Etude et l’Exploitation des Procedes Georges Claude, Paris (FR)

(72) Inventors: Remi GONIN, Jouy-en-Josas (FR); Fouad AMMOURI, Jouy-en-Josas (FR); David VEMPAIRE, Sassenage (FR)

(73) Assignee: L'Air Liquide, Societe Anonyme pour l'Etude et l’Exploitation des Procedes Georges Claude, Paris (FR)

(21) Appl. No.: 18/784,581

(22) Filed: Jul. 25, 2024

(30) Foreign Application Priority Data
Jul. 25, 2023 (FR) FR 2307995

(51) Int. Cl. F17C 13/02; F17C 5/00; G01F 17/00

(52) U.S. Cl. CPC F17C 13/028; F17C 5/00; G01F 17/00; F17C 2221/012; F17C 2250/0426

(57) ABSTRACT

A method for estimating a volume of a reservoir to be filled from a station for distributing a pressurized fluid including injecting a flow of pressurized fluid into the reservoir, determining a pressure variation in the reservoir, the pressure variation being determined with respect to an initial pressure, determining an amount of the fluid flow injected into the reservoir, and estimating the volume of the reservoir to be filled, on the basis of the amount of the fluid flow injected into the reservoir and on the basis of the pressure variation in the reservoir after the injection of the fluid flow. Wherein the volume of the reservoir to be filled is also estimated on the basis of an injection temperature, and on the basis of a temperature variation in the reservoir after the injection of the fluid flow.

### CROSS-REFERENCE TO RELATED APPLICATIONS

This application claims the benefit of priority under 35 U.S.C. § 119 (a) and (b) to French patent application No. FR2307995, filed Jul. 25, 2023, the entire contents of which are incorporated herein by reference.

### BACKGROUND

The invention relates to a method for estimating a volume of a reservoir to be filled from a pressurized fluid distribution station. The fluid to be transferred may be gaseous hydrogen. The reservoir to be filled may be incorporated into a vehicle, notably a vehicle having a fuel cell.

### FIELD OF THE INVENTION

The method for estimating a volume of a reservoir to be filled usually comprises the following steps:
a step of injecting a flow of pressurized fluid into the reservoir,
a step of determining a pressure variation in the reservoir after the injection of the flow of fluid, the pressure variation being determined with respect to an initial pressure of the reservoir before the injection,
a step of determining a quantity of the flow of fluid injected into the reservoir, and
a step of estimating the volume of the reservoir to be filled, on the basis of the quantity of fluid flow injected into the reservoir and on the basis of the pressure variation in the reservoir after the injection of the flow of fluid.

By knowing the volume of the reservoir to be filled, it is possible, notably, to determine a pressure gradient according to which the reservoir will be filled.

If the reservoir volume can be communicated to the fluid distribution station by means of a communication system installed in the vehicle housing the reservoir to be filled, then, in the absence of such a communication system, or for the purpose of verifying data communicated by this communication system, the distribution station must be capable of independently estimating the volume of the reservoir to be filled.

### RELATED ART

Existing methods provide an estimate of the volume of a reservoir to be filled which is far from accurate, and therefore a correction coefficient must usually be applied in order to approximate the actual reservoir volume to be filled.

Furthermore, the correction coefficient depends on the dimensions of the reservoir to be filled and on the filling scenario (initial pressure, injection temperature, etc.). Thus, according to the existing methods for estimating the volume of a reservoir to be filled, this correction coefficient has to be recalculated.

Document FR0955229 also discloses a method for estimating the volume of a reservoir to be filled, which has the advantage of being more accurate. However, this method suffers from the drawback of requiring a relatively high number of calculations and an iterative procedure for making such calculations converge on a value of volume. It may also be the case that the iterative procedure according to this method does not converge on any value of volume.

With the growing development of the market for fuel cell vehicles, and in view of the variety of reservoirs to be filled and the variety of filling stations, there is evidently a need to develop a volume estimation method that will be simple and universal, and will provide more accurate results.

### SUMMARY OF THE INVENTION

To this end, the invention, while conforming to the generic definition given by the above preamble, is characterized in that the reservoir volume to be filled is also estimated on the basis of an injection temperature, that is to say a temperature of the fluid flow entering the reservoir, and on the basis of a temperature variation in the reservoir after the injection of the fluid flow, the temperature variation being determined with respect to an initial temperature of the reservoir before the injection.

Thus, for the estimation of the volume of a reservoir to be filled, the method according to the invention considers a thermodynamic hypothesis (namely, that the temperature varies after injection) which is closer to reality. In this way, the invention differs from the prior art, in which the temperature of the fluid in the reservoir is assumed to be constant during the injection.

Furthermore, by considering the injection temperature and the variation of the temperature of the fluid in the reservoir after the injection, the method according to the invention makes it possible to obtain a more accurate estimate of the volume of a reservoir. Thus, the invention makes it unnecessary to provide a correction coefficient, and enables the volume estimation of any type of reservoir to be estimated, regardless of the filling scenario encountered at the distribution station.

The invention also enables the volume to be estimated directly, without an iterative procedure.

Embodiments of the invention can comprise one or more of the following characteristics:
The initial temperature is estimated at the ambient temperature.
The volume of the reservoir to be filled is related to the amount of fluid flow injected, to the pressure variation, to the injection temperature and to the variation of the temperature in the reservoir, via a function obtained from an equation of state applied to the fluid in the reservoir and from an enthalpy balance applied to the same fluid in the reservoir.

The equation of state applied to the fluid in the reservoir is an ideal gas equation:

$$pV = \frac{m}{M} R z ( p , T ) T$$

where p [Pa], V [m³], T [K], m [kg], M [kg/mol] and z (unitless) are, respectively, the pressure, the volume, the temperature, the mass, the molar mass and the compressibility of the fluid in the reservoir to be filled, and R [J/mol·K] is the ideal gas constant.

The function linking the reservoir volume to the injection temperature, the amount of fluid flow injected into the reservoir, the pressure variation in the reservoir, and the temperature variation in the reservoir can be written in the form of a product of two factors:
a first, constant, factor depending solely on the amount of fluid flow injected into the reservoir and the pressure variation in the reservoir, and
a second factor f(T₀, Tᵢₙⱼ, p₀) depending on the initial pressure in the reservoir, the injection temperature and the initial temperature.

The second factor can be written thus:

$$f ( {T}_{0} , {T}_{inj} , {p}_{0} ) = [ {rzT}_{0} + \frac{r ( z + {T}_{0} \frac{\partial z}{\partial T} ) ( h ( {p}_{0} , {T}_{inj} ) - h ( {p}_{0} , {T}_{0} ) )}{{c}_{p}} ] / [ 1 - r ρ {T}_{0} \frac{\partial z}{\partial p} - r ( z + {T}_{0} \frac{\partial z}{\partial T} ) \frac{{BT}_{0}}{{c}_{p}} ]$$

where cₚ[J/(kg·K)], β[1/K], p[kg/m³] and h(p₀, T₀) [J/kg] are, respectively, the mass heat capacity, the isobaric expansion coefficient, the density and the mass enthalpy of the fluid in the reservoir; h(p₀, Tᵢₙⱼ) [J/kg] is the mass enthalpy of the fluid flow injected into the reservoir, and r is the ratio between the ideal gas constant R [J/mol·K] and the molar mass M [kg/mol] of the fluid in the reservoir to be filled.

The second factor f(T₀, Tᵢₙⱼ, p₀) is approximated by an interpolation polynomial f*(T₀, Tᵢₙⱼ, p₀).

The interpolation polynomial f*(T₀, Tᵢₙⱼ, p₀) of the second factor f(T₀, Tᵢₙⱼ, p₀) is a second degree polynomial with three variables (T₀, Tᵢₙⱼ, p₀) representing, respectively, the initial temperature of the fluid in the reservoir, the injection temperature, and the initial pressure of the fluid in the reservoir.

The reservoir to be filled is fluidly connected to a source reservoir of the fluid distribution station via a distributor.

The amount of fluid flow injected into the reservoir, and the pressure variation in the reservoir, are measured by means of sensors positioned in the distributor.

### BRIEF DESCRIPTION OF THE FIGURES

Other particular features and advantages will become apparent from reading the following description, provided with reference to the following figures, in which:

FIG. 1 shows schematically a reservoir to be filled, fluidly connected to a pressurized fluid distribution station;

FIG. 2 shows schematically the steps of the method according to the invention.

### DETAILED DESCRIPTION OF THE INVENTION

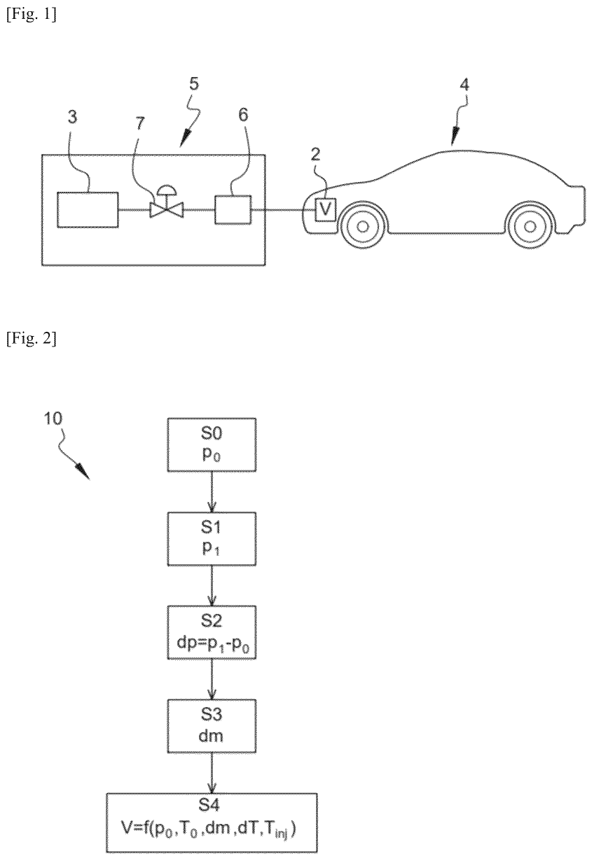

As shown in [FIG. 1], the invention relates to a method 10 for estimating a volume V of a reservoir 2 (the receiving reservoir) to be filled from a source reservoir 3 containing a pressurized fluid.

With reference to [FIG. 2], the reservoir 2 to be filled may be incorporated into a vehicle 4, notably a vehicle having a fuel cell. The source reservoir 3 may be installed at a pressurized fluid distribution station 5. The fluid concerned may be gaseous hydrogen.

In particular, the distribution station 5 also comprises a distribution member 6 and a valve 7 positioned between the source reservoir 3 and the distribution member 6.

The distribution member 6 comprises a filling line connected to the source reservoir 3, together with a nozzle (not shown) for engaging in a receptacle provided in the vehicle 4 containing the reservoir 2 to be filled. The distribution member 6 may also be equipped with sensors (not shown) for measuring, respectively, the temperature, the pressure, and the flow rate of a fluid flow entering the reservoir 2 to be filled.

The estimation method 10 comprises a step S0, consisting in connecting the distribution member 6 of the station 5 to the receptacle of the vehicle 4 containing the reservoir 2 to be filled (fluid communication between the filling line comprising the distribution member and the volume of the reservoir 2). In this step S0, the valve 7 remains closed. Pressure balancing takes place between the distribution member 6 and the reservoir 2 to be filled. This balancing makes it possible to determine or measure the initial pressure p0 of the reservoir 2 to be filled.

In the same step S0, the ambient temperature is measured by the distribution station 5. This can be used to estimate the initial temperature T₀ in the reservoir 2 to be filled.

In a step S1, the valve 7 is opened for a relatively short time interval, a few seconds in length (for example, 5 s; in other words, there is an injection of a discrete, or “pulsed” jet). The fluid from the source reservoir 3 is then injected into the reservoir 2 to be filled according to a predefined pressure gradient, for example 5 bar/s. The injection of the fluid into the reservoir 2 to be filled causes an increase in the pressure measured by the pressure sensor.

After the closure of the valve 7, the pressure measured by the pressure sensor decreases to a certain value p1. This pressure p1 is identical to that of the reservoir 2 to be filled.

In a step S2, the method 10 provides a measurement of the pressure variation between the start t0 and the end t1 of injection. This pressure variation can be written dp=p₁−p₀. Additionally, in this same step S2 or a different step S3, the method 10 also provides for the measurement of the amount dm of fluid flow injected into the reservoir 2 to be filled.

The amount dm of the fluid flow injected into the reservoir 2 to be filled (referred to below simply as the amount dm of material) can be obtained by temporal integration of the mass flow rate between the instants t₀ and t₁:

$$dm = {\int }_{{t}_{0}}^{{t}_{1}} \dot{m} dt$$

In a step S4 of the method 10, the volume V of the reservoir to be filled is determined. The calculation of the volume V of the reservoir 2 to be filled takes into account the variation dp of pressure, the amount dm of the fluid flow injected into the reservoir 2 to be filled, and the initial temperature T₀ of the reservoir 2 to be filled.

According to the invention, the calculation of the volume V also takes into account an injection temperature Tᵢₙj, that is to say a temperature of the fluid flow entering the reservoir 2 to be filled, and a temperature variation dT in the reservoir 2 after the injection of the fluid flow, the temperature variation being determined with respect to the initial temperature T₀ of the reservoir 2 before the injection.

The initial pressure p₀ and the initial temperature T₀ of the reservoir 2 before the injection, the temperature variation dT, and the variation of mass dm in the reservoir 2 after the injection, together with the injection temperature Tᵢₙⱼ, are taken into account in the estimation of the volume V of the reservoir 2 to be filled by means of a correlation that can be written as follows:

V=f(p₀,T₀,dT,dm,Tᵢₙⱼ)

The above correlation is obtained from an equation of state applied to the fluid flow into the reservoir 2 to be filled, and from an enthalpy balance applied to the same flow.

Advantageously, the fluid being considered as an ideal gas, the equation of state applied to the fluid injected into the reservoir 2 to be filled can be written as follows:

$$pV = \frac{m}{M} R z ( p , T ) T$$

where p [Pa], V [m³], T [K], m [kg], M [kg/mol] and z (unitless) are, respectively, the pressure, the volume, the temperature, the mass, the molar mass and the compressibility of the fluid in the reservoir to be filled, and R [J/mol·K] is the ideal gas constant.

The enthalpy balance of the fluid in the reservoir 2 to be filled is written as follows:

$$m {c}_{p} \frac{d T}{d t} = V β T \frac{d p}{d t} + {k}_{g} {S}_{w} ( {T}_{g , w} - T ) + \frac{d m}{d t} ( h ( p , {T}_{i n j} ) + \frac{{u}_{i n j}^{2}}{2} - h ( p , T ) )$$

where
β [1/K], cp [J/(kg·K)], and h [J/kg] are, respectively, the isobaric expansion coefficient, the mass heat capacity and the mass enthalpy of the gas;
uᵢₙⱼ [m/s] is the velocity of the injection gases;
S_{w} [m2], T_{g,w} [K], and kg [W/m²/K] are, respectively, the internal surface area of the reservoir, the mean temperature of the surface of the inner wall, and the heat transfer coefficient between the gas and the wall.

Disregarding the heat exchange between the gas and the wall of the reservoir to be filled (that is to say, assuming that k_{g}S_{w}(T_{g,w}−T)≈0), and disregarding the kinetic energy of the fluid relative to the enthalpy (that is to say, assuming that

$$\frac{{u}_{i n j}^{2}}{2} ≪ h ) ,$$

the enthalpy balance can be written thus:

$$dT \approx \frac{V β T}{m {c}_{p}} d p + \frac{( {h}_{i n j} - h ( p , T ) )}{m {c}_{p}} d m .$$

After the derivation of the equation of state shown above, and the combination of the derived expression with the simplified expression of the enthalpy balance above, the correlation between the volume V of the reservoir 2 to be filled, the injection temperature Tᵢₙⱼ, the amount dm, the pressure variation dp, and the temperature variation dT can be written as follows:

$$V = f ( {T}_{0} , {T}_{i n j} , {p}_{0} ) \frac{d m}{d p} , where f ( {T}_{0} , {T}_{inj} , {p}_{0} ) = \frac{( {rzT}_{0} + \frac{r ( z + {T}_{0} \frac{\partial z}{\partial T} ) ( h ( {p}_{0} , {T}_{i n j} ) - h ( {p}_{0} , {T}_{0} ) )}{{c}_{p}} )}{( 1 - r ρ {T}_{0} \frac{\partial z}{\partial p} - r ( z + {T}_{0} \frac{\partial z}{\partial T} ) \frac{β {T}_{0}}{{c}_{P}} )}$$

The initial temperature T₀ can be approximated by an ambient temperature measured at the distribution station 5.

It should be noted that the function f(T₀, Tᵢₙⱼ, p₀) is determined on the basis of ideal gas data supplied by the literature, such as the data issued by the National Institute of Standards and Technology (NIST).

In the absence of ideal gas data, and/or for the purpose of a fast and accurate machine calculation of the volume, the invention provides for the use of an interpolation polynomial f*(T₀, Tᵢₙⱼ, p₀) in place of the function f(T₀, Tᵢₙⱼ, p₀).

Advantageously, the interpolation polynomial f*(T₀, Tᵢₙⱼ, p₀) can be a second degree polynomial with three variables (T₀, Tᵢₙⱼ, p₀). This polynomial can be written as follows:

$${f}^{*} ( {T}_{1} , {T}_{i n j} , {p}_{1} ) = {a}_{0} + {a}_{1} {p}_{1} + {a}_{2} {T}_{i n j} + {a}_{3} {T}_{i n j} {p}_{1} + {a}_{4} {T}_{1} + {a}_{5} {T}_{1} {p}_{1} + {a}_{6} {T}_{i n j} {T}_{1} + {a}_{7} {T}_{1} {T}_{i n j} {p}_{1} + {a}_{8} {T}_{1}^{2} + {a}_{9} {T}_{i n j}^{2} + {a}_{10} {p}_{1}^{2}$$

The coefficients aᵢ (where i∈[0, 10]) of the interpolation polynomial f*(T₀, Tᵢₙⱼ, p₀) can be determined by a least squares linear regression method.

A validation study of the method according to the invention has shown that the volume V estimated using the interpolation polynomial f*(T₀, Tᵢₙⱼ, p₀) differs very little from the volume V estimated using the function f(T₀, Tᵢₙⱼ, p₀). Furthermore, an approximation of the initial temperature T₀ by the ambient temperature measured at the station gives satisfactory results.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A method for estimating a volume (V) of a reservoir to be filled from a station for distributing a pressurized fluid such as gaseous hydrogen, the method comprising:
injecting a pressurized fluid into the reservoir,
determining a pressure variation (dp) in the reservoir after the injection of the flow of fluid, the pressure variation being determined with respect to an initial pressure (p₀) of the reservoir before the injection,
determining an amount (dm) of fluid flow injected into the reservoir,
estimating the volume (V) of the reservoir to be filled on the basis of the amount (dm) of the fluid flow injected into the reservoir and on the basis of the pressure variation (dp) in the reservoir after the injection of the fluid flow,
wherein the volume (V) of the reservoir to be filled is also estimated on the basis of an injection temperature (Tᵢₙⱼ), wherein the injection temperature (Tᵢₙⱼ) comprises a temperature of the fluid flow entering the reservoir, and on the basis of a temperature variation (dT) in the reservoir after the injection of the fluid flow, the temperature variation being determined with respect to an initial temperature (T₀)) of the reservoir before the injection.

2. The method of claim 1, wherein the initial temperature (T₀) is estimated to be equal to the ambient temperature.

3. The method of claim 1, wherein the volume (V) of the reservoir to be filled is related to the amount (dm) of the fluid flow injected, to the pressure variation (dp), to the injection temperature (Tᵢₙⱼ) and to the temperature variation (dT) in the reservoir by means of a function obtained from an equation of state applied to the fluid in the reservoir and from an enthalpy balance applied to the same fluid in the reservoir.

4. The method of claim 3, wherein the equation of state applied to the fluid in the reservoir is an ideal gas equation given by:
$$pV = \frac{m}{M} R z ( p , T ) T$$
where p [Pa], V [m³], T [K], m [kg], M [kg/mol] and z (unitless) are, respectively, the pressure, the volume, the temperature, the mass, the molar mass and the compressibility of the fluid in the reservoir to be filled, and R [J/mol·K] is the ideal gas constant.

5. The method of claim 3, wherein the function relating the volume (V) of the reservoir to the injection temperature (Tᵢₙⱼ), the amount (dm) of the fluid flow injected into the reservoir, the pressure variation (dp) in the reservoir and the temperature variation (dT) in the reservoir can be written in the form of a product of two factors:
a first, constant, factor depending solely on the amount (dm) of the fluid flow injected into the reservoir and on the pressure variation (dp) in the reservoir, and a
second factor f(T₀, Tᵢₙⱼ, p₀) depending on the initial pressure (p₀) in the reservoir, on the injection temperature (Tᵢₙⱼ) and on the initial temperature (T₀).

6. The method of claim 5, wherein the second factor f(T₀, Tᵢₙⱼ, p₀) is written as follows:
$$f ( {T}_{0} , {T}_{inj} , {p}_{0} ) = [ {rzT}_{0} + \frac{r ( z + {T}_{0} \frac{\partial z}{\partial T} ) ( h ( {p}_{0} , {T}_{i n j} ) - h ( {p}_{0} , {T}_{0} ) )}{{c}_{p}} ] / [ 1 - r ρ {T}_{0} \frac{\partial z}{\partial p} - r ( z + {T}_{0} \frac{\partial z}{\partial T} ) \frac{β {T}_{0}}{{c}_{p}} ]$$
where cₚ[J/(kg·K)], β[1/K], p[kg/m³] and h(p₀, T₀) [J/kg] are, respectively, the mass heat capacity, the isobaric expansion coefficient, the density and the mass enthalpy of the fluid in the reservoir; h(p₀, Tᵢₙⱼ) [J/kg] is the mass enthalpy of the fluid flow injected into the reservoir, and r is the ratio between the ideal gas constant R [J/mol·K] and the molar mass M [kg/mol] of the fluid in the reservoir to be filled.

7. The method of claim 6, wherein the second factor f(T₀, Tᵢₙⱼ, p₀) is approximated by an interpolation polynomial f*(T₀, Tᵢₙⱼ, p₀).

8. The method of claim 7, wherein the interpolation polynomial f*(T₀, Tᵢₙⱼ, p₀) of the second factor f(T₀, Tᵢₙⱼ, p₀) is a second degree polynomial with three variables (T₀, Tᵢₙⱼ, p₀) representing, respectively, the initial temperature of the fluid in the reservoir, the injection temperature, and the initial pressure of the fluid in the reservoir.

9. The method of claim 1, wherein the reservoir to be filled is fluidly connected to a source reservoir of the fluid distribution station via a distributor, the amount (dm) of fluid injected into the reservoir and the pressure variation (dp) in the reservoir being measured by means of sensors positioned at the distributor.
